(19) United States
(12) Patent Application Publication
(10) Pub. No.: US 2025/0240668 A1
(43) Pub. Date: Jul. 24, 2025

(54) QUALITY OF SERVICE SUPPORT FOR SERVICE TRAFFIC REQUIRING IN-NETWORK COMPUTING IN MOBILE NETWORKS

(71) Applicant: HUAWEI TECHNOLOGIES CO., LTD., Shenzhen (CN)

(72) Inventor: Qing Wei, Munich (DE)

(73) Assignee: HUAWEI TECHNOLOGIES CO., LTD., Shenzhen (CN)

(21) Appl. No.: 19/176,476

(22) Filed: Apr. 11, 2025

Related U.S. Application Data
(63) Continuation of application No. PCT/EP2022/078168, filed on Oct. 11, 2022.

(51) Int. Cl. H04W 28/02

(52) U.S. Cl. CPC H04W 28/0268

(57) ABSTRACT

This disclosure proposes a control plane entity and a user control plane entity for supporting quality of service for service traffic requiring in-network computation. The control plane entity receives a service description, one or more service requirements, and INC information. It segments the service data flow into a plurality of segments based on the INC information, the segments being linked by application layer computing operations to be performed on the service data flow. It selects at least one user plane entity based on the INC information for performing an application layer computing operation, determines QoS parameters for each segment, and provides QoS configuration information according to the QoS parameters to the at least one user plane entity. The at least one user plane entity performs the application layer processing operation on the service data flow, and enforces the QoS parameters based on the QoS configuration.

### CROSS-REFERENCE TO RELATED APPLICATIONS

This application is a continuation of International Application No. PCT/EP2022/078168, filed on Oct. 11, 2022, the disclosure of which is hereby incorporated by reference in its entirety.

### TECHNICAL FIELD

The present disclosure relates to a mobile communication network, for instance, a New Radio (NR) or 5th generation (5G) mobile network. The disclosure proposes a control plane entity and a user plane entity, and corresponding methods. The user plane entity is configured for in-network computing (INC) to be performed on service traffic in the user plane of the mobile communication network. The control plane entity is configured to support the quality of service (QOS) for the service traffic when the INC is applied.

### BACKGROUND

Emerging applications, such as XR (Virtual Reality (VR), Argument Reality (AR), Mixed Reality (MR)), or Metaverse, or Machine Learning (ML) enabled applications, pose new requirements to mobile communication networks. For instance, VR glasses need to perform intensive computation tasks for video rendering, while at the same time they have to be designed with a light weight, with a constrained size, and thus have limited computing and battery capacity. INC is a solution that offloads application layer computation tasks from light end devices to network entities.

Further, XR, Metaverse and ML enabled applications introduce much more network traffic than before, considering high resolution videos, and continue data collection from a big amount of end devices in parallel. INC is again a solution, as it may improve the efficiency of resource usage, e.g., via traffic aggregation, compression, content caching, multicasting, and raw data pre-processing such as feature subtraction.

In a 3GPP network, service traffic from a User Equipment (UE) is transferred via the Radio Access Network (RAN) and User Plane Functions (UPFs) to the application server (AS), which is deployed at a Mobile Edge Platform (MEP) or a Data Network (DN) for application layer processing, or vice versa.

According to the 3GPP's definition, computational tasks at the application layer (in contrast to at the network layer) are considered as application service that is provided in the DN or the MEP, i.e., in any case outside of the 3GPP network domain. The 3GPP network provides only a transport service for the application traffic between UE and the DN or MEP via the N6 interface, as shown in FIG. 1. The UPF(s) perform(s) only network layer treatment for the packets in a service traffic flow, e.g., the packets are forwarded to a certain port of the UPF which is connected to other network entities, are prioritized for network transport or dropped in case of network resource shortage, or are duplicated for better transport reliability.

In addition, the mobile network provides a QoS assurance for the service traffic transport service in the complete segment between the UE and the N6 interface (for uplink (UL) traffic and/or downlink (DL) traffic) or between the UEs (directly via the PC5 interface, or for both UL traffic and DL traffic via a UPF). Since there is no intermediate application layer processing during the traffic transport in the mobile network, the QoS requirements is end to end (e2e) for a specific service data flow.

### SUMMARY

In a 3GPP network since 5G or later, application service data with different Qos requirements are mapped into QoS flows using packet filters (e.g., packet detection rules (PDRs) at the UPF, QoS rules at the UE). Each QoS flow is identified using a QoS flow ID (i.e., marked with QFI) and binds to a QoS profile. A QoS profile includes QoS parameters, which indicate how this QoS flow should be treated in the mobile network. The QoS parameters include, e.g., 5QI (a scalar that is used as a reference to predefined 5G QoS characteristics), or 5G QoS characteristics, e.g., packet delay budget (PDB), guaranteed bite rate (GBR), etc.

At the UPF, service traffic is classified into different QoS flows based on the PDR. The classified traffic flows are treated according to a set of instructions that binds to that PDR (e.g., forwarding action rule (FAR), QoS enforcement Rule (QER), Usage Reporting Rule (URR)) at the UPF.

A FAR specifies packet treatments, such as drop, forwarding, buffer, duplicate, eliminate duplicated packets. A QER specifies the rules on the QoS enforcement. A URR specifies the rules on related notification and/or reporting to a control plane entity, e.g., a Control Plane Network Function (CP-NF). The set of instructions may be provided by the control plane entity, which may be the Session Management Function (SMF) in the 5G system.

In a 5G system, the PCF obtains a flow description of a certain service data flow (e.g., between UE and N6 interface) together with service requirements from the Application Function (AF), or a Unified Data Repository (UDR). The PCF further determines policy charging control (PCC) rules including flow descriptions and the QoS parameters to be used for this flow in the mobile network, and provides them to the SMF, as shown in FIG. 2. The SMF selects the UPFs (e.g., based on UE location, UPF load, etc.), to transport this flow, and configures the PDR and related sets of instructions of the selected UPFs accordingly. The first UPF after the service traffic enters the mobile network (e.g., the N6 UPF) detects the service data flow based on the PDR, and marks the flow with a flow ID. The follow up UPFs can identify this flow by the flow ID in the PDR. In this way, each UPF may be able to apply a related sets of instructions for this service data flow.

This disclosure has the aim to integrate INC into a next generation mobile network (e.g., 5G+, 6G). It may be understood that the above-described situations would change when INC would be applied to a service data flow in the mobile network (e.g., if the service data flow would be processed by one or more user plane entities during its transport though the mobile network). The traffic pattern and characteristic of the service data flow would change after each application layer processing at a user plane entity, and also QoS requirements would change.

For example, a VR glasses (acting as a UE) may send sensor data to a VR server (acting as an AS deployed in a DN). Application layer processing at one or more user plane entities—i.e. INC applied to the service data flow comprising the sensor data-could be used to compress or subtract features of the sensor data, as shown in FIG. 3a. The required bandwidth for the service data flow transport could thus be reduced from 1 Mbps to 0.1 Mbps after the application layer processing.

In another example, shown in FIG. 3b, service data flows from multiple UEs may be aggregated to one service data flow at a user plane entity (e.g., to reduce the processing load/congestion at the AS) and be transported further to the AS. Here, the traffic pattern of the service data flow changes after the INC.

Similarly, in the content caching scenario shown in FIG. 3c, requested contents by a UE can be multicast by a user plane entity on the UE path, if that user plane entity is also on the path of other UEs with the same content request.

In another implementation, a user plane entity, after receiving the service data from a UE, replicates and sends it to both the AS and another UE (e.g., for the saving of requested radio resources). Here the traffic pattern also changes after the INC.

Therefore, the current 3GPP QoS mechanism as explained above, does not apply anymore to such cases with changed traffic pattern and QoS requirements, when the service traffic is transported through the 3GPP network. In addition, the QoS assurance in the mobile network would also be different with INC. Except for the transport latency (e.g., PDB), the application layer processing and a transport of a service data flow between the network transport layer and the application layer (e.g., due to the queuing, packet de/encapsulation) would introduce additional latency in the network. However, none of this is considered in the current 3GPP procedures and messages.

In view of the above, this disclosure aims to provide a solution for QoS support for service traffic that requires INC in a mobile network. An objective is to provide a solution for deriving QoS policy rules for a service data flow requiring INC. Another objective is to provide a solution for determining QoS parameters for such a service data flow requiring INC. Another objective is to provide a solution for enforcing QoS for such a service data flow requiring INC.

These and other objectives are achieved by this disclosure as described in the independent claims. Advantageous implementations are further defined in the dependent claims.

Notably, in this disclosure, a user plane entity with application layer processing capability (INC capability) may be referred to as a computing UPF (cUPF) for simplicity. A cUPF may contain computing logic that is defined and deployed according to the requirement(s) of an application.

A first aspect of this disclosure provides a control plane entity for assuring QoS of a service data flow transported through a user plane of a network, the control plane entity being configured to: receive, from an application, a service description for the service data flow and one or more service requirements for the service data flow, and INC information including a list of one or more sets of identifiers, wherein each identifier is associated with an application layer computing operation to be performed on the service data flow in the user plane, and wherein the identifiers in the same set are associated with the same application layer computing operation; segment the service data flow into a plurality of consecutive segments based on the INC information, wherein each two subsequent segments are linked by one of the application layer computing operations to be performed on the service data flow in the user plane; determine a plurality of QoS parameters for the service data flow based on the one or more service requirements, wherein the plurality of QoS parameters include one or more QoS parameters for each segment of the plurality of consecutive segments; select a user plane entity for each set of identifiers in the list based on the INC information, wherein each selected user plane entity is configured to perform the application layer computing operation that is associated with the identifier; and provide, to the one or more selected user plane entities, Qos configuration information according to the plurality of QoS parameters for the service data flow.

The set of identifiers in the list may be ordered. This order may correspond to an order of the application layer computing operations that are to be performed on the service data flow.

The control plane entity may maintain a mapping of identifiers to user plane entities in the network, e.g., based on the configuration from a management entity.

The control plane entity of the first aspect is part of the solution of this disclosure for QoS support for service traffic requiring INC in the mobile network. In particular, the control plane entity can determine QoS parameters and QoS configuration, which may implement QoS policy rules, for the service data flow. The QoS configuration information can be used by the one or more selected user plane entities to enforce QoS for the service data flow.

In an implementation form of the first aspect, the control plane entity is further configured to: receive, from the application, a service description indicating a group of service data flows that are associated with each other, a group service requirement for the group of service data flows, and one or more service requirements for each service data flow of the group of service data flows; identify the segments with a group of service data flows; determine the plurality of QoS parameters for the group of service data flows in the segment, wherein a set of QoS parameters is determined for each service data flow of the group of service data flows based on the one or more service requirements for that service data flow; determine one or more group QoS parameters for the group of service data flows in the segment based on the group service requirement; and provide, to the one or more selected user plane entities, the QoS configuration information according to the plurality of QoS parameters for the service data flows of the group of service data flows and according to the group QoS parameter for the group of service data flows.

Accordingly, the determining of the QoS parameters and the QoS enforcement are also possible for a group of service data flows, e.g., aggregated service data flows. That is, group QoS can be implemented by the control plane entity.

In an implementation form of the first aspect, the one or more service requirements include an end-to-end service requirement for the service data flow or for each segment of the service data flow linked by one of the application layer computing operations.

In an implementation form of the first aspect, the control plane entity is further configured to: determine an end-to-end QoS parameter, for example an end-to-end delay, based on an end-to end service requirement received from the application and/or based on the plurality of consecutive segments determined by the control plane entity based on the INC information; and select the one or more user plane entities based further on the end-to-end Qos parameter.

In an implementation form of the first aspect, the control plane entity is further configured to provide, to the one or more selected user plane entities, the QoS configuration information further according to the end-to-end QoS parameter.

According to the above implementation forms, end-to-end QoS for the service data flow through the network can be enforced.

In an implementation form of the first aspect, the control plane entity is further configured to dynamically select the one or more user plane entities based on the end-to-end QoS parameter and based on a status of the user plane of the network and/or a load of the user plane entities of the user plane.

The status of the user plane may be a status of the user plane entites, which may include user plane entities configured for application layer processing (performing application layer computing operations) and user plane entities not configured for application layer processing. The status of a user plane entity may comprise a latency, for example, a forwarding latency at the user plane entity, or a packet dealy, or an application layer or network layer processing delay, or the like. The status and/or the load of the user plane entity can be reported by the user plane entity to the control plane entity. Therefore, the QoS of the service data flow can be assured at different status or loads, and/or can be maintained if the status or load changes. Maintaining the QoS may comprise reselecting user plane entites configured for application layer processing and/or resegmenting the service data flow, if the status or load changes. The reselection and/or resegmentation may guarantee the QoS of the service data flow over its life time.

In an implementation form of the first aspect, the control plane entity is further configured to determine the one or more QoS parameters for each segment of the plurality of consecutive segments by mapping said segment to one or more QoS models that exists in the network.

In this disclosure, determining the QoS parameters may comprise determining a type of QoS parameters and/or determining a value of one or more of the QoS parameters. The existing QoS model may have a certain traffic description and certain set of QoS parameter types, e.g., broadcast/multicast QoS, flow QoS.

In an implementation form of the first aspect, the control plane entity is further configured to determine the one or more QoS parameters for each segment of the plurality of consecutive segments based on a QoS granularity, wherein the QoS granularity indicates whether the plurality of QoS parameters relate to a service data flow, or to one or more frames or one or more sub-flows of the service data flow, or to multiple service data flows.

In an implementation form of the first aspect, the QoS configuration information is configured to instruct the one or more selected user plane entities to enforce the plurality of QoS parameters, and/or to enforce the one or more group QoS parameters, and/or to enforce the end-to-end QoS parameter.

In an implementation form of the first aspect, the control plane entity is further configured to provide, to the one or more selected user plane entities, QoS reporting information which indicates a QoS reporting rule to each of the one or more selected user plane entities for reporting monitoring results related to plurality of QoS parameters to the control plane entity, wherein the monitoring results include at least one of: a monitored packet delay for the packets processed by the application layer at the user plane entities per application; a monitored cross layer latency; a monitored forwarding latency from network layer to application layer; a monitored forwarding latency from application layer to network layer; a monitored forwarding latency between application layer and network layer; a monitored application layer processing delay per application.

Here the cross layer latency or forwarding latency can be per application or common for all the applications depending on the implementation of the user plane entities (e.g., per application queue or shared queue for multiple applications between the network layer and application layer).

The monitoring results may further include at least one of a monitored cross layer packet loss or error rate; a monitored cross layer queue length or congestion level; monitored packet error rate of a segment; a monitored flow bit rate of a segment.

In an implementation form of the first aspect, the control plane entity comprises a PCF and a SMF; wherein the PCF is configured to segment the service data flow, and to determine the plurality of QoS parameters; and wherein the SMF is configured to select the one or more user plane entities, adjust the plurality of QoS parameters according to the selected one or more user plane entities, and to provide the QoS configuration information to the one or more selected user plane entity.

In an implementation form of the first aspect, the PCF is configured to receive the information from the application and provide a QoS policy including at least the plurality of QoS parameters to the SMF.

In an implementation form of the first aspect, the plurality of QoS parameters for the service data flow include one or more of: a packet error rate; a packet delay budget; a guaranteed flow bit rate; a core network packet delay budget; a core network guaranteed flow bit rate; a cross layer latency; a forwarding latency from network layer to application layer; a forwarding latency from application layer to network layer; a forwarding latency between application layer and network layer; an application layer processing delay per application.

The cross layer latency and the forwarding latencies may be parameters in the enforcement rules for the user plane entities to compute, for instance, whether the PDB is exceeded using the local monitoring results. The application layer processing delay per application may be given by each application as a static value.

A second aspect of this disclosure provides user plane entity for assuring QoS of a service data flow transported through a user plane of a network, the user plane entity being configured to: receive a service data flow from another user plane entity, or from a RAN, or from a DN; receive QoS configuration information from a control plane entity, the QoS information including one or more QoS parameters for the service data flow; and perform an application layer processing operation on the service data flow; and enforcing the one or more QoS parameters based on the QoS configuration.

In this disclosure, the service data flow can be carried as payload in a network traffic flow.

The user plane entity of the second aspect is part of the solution of this disclosure for QoS support for service traffic requiring INC in the mobile network. In particular, the user plane entity performs the INC on the service data flow. Further, based on the QoS configuration information, the user plane entity can enforce QoS for the service data flow by enforcing the one or more QoS parameters.

In an implementation form of the second aspect, the user plane entity is further configured to: receive, from the control plane entity, QoS reporting information which indicates a QoS reporting rule; and provide a report, to the control plane entity after performing the application layer processing on the service data flow, wherein the report indicates whether the one or more QoS parameters could be enforced and/or a value of the one or more enforced QoS parameters.

In this way, the control plane entity is informed about the enforced QoS parameters, and can react accordingly. For instance, it may determine new QoS parameters and/or provide a new QoS configuration information to the one or more selected user plane entities. It may use the reported QoS parameters for the selection or reselection of the user plane entities of a service data flow.

In an implementation form of the second aspect, the user plane entity is a UPF.

A third aspect of this disclosure provides a method for assuring QoS of a service data flow transported through a user plane of a network, the method comprising: receiving, from an application, a service description for the service data flow and one or more service requirements for the service data flow, and INC information including a list of one or more sets of identifiers, wherein each identifier is associated with an application layer computing operation to be performed on the service data flow in the user plane, and wherein the identifiers in the same set are associated with the same application layer computing operation; segmenting the service data flow into a plurality of consecutive segments based on the INC information, wherein each two subsequent segments are linked by one of the application layer computing operations to be performed on the service data flow in the user plane; determining a plurality of QoS parameters for the service data flow based on the one or more service requirements, wherein the plurality of QoS parameters include one or more QoS parameters for each segment of the plurality of consecutive segments; selecting a user plane entity for each set of identifiers in the list based on the INC information, wherein each selected user plane entity is configured to perform the application layer computing operation that is associated with the identifier; and determining QoS configuration information according to the plurality of QoS parameters for the service data flow; and providing, to the one or more selected user plane entities.

In an implementation form of the third aspect, the method further comprises: receiving, from the application, a service description indicating a group of service data flows that are associated with each other, a group service requirement for the group of service data flows, and one or more service requirements for each service data flow of the group of service data flows; identify the segments with a group of service data flows; determining the plurality of QoS parameters for the group of service data flows in the segment, wherein a set of QoS parameters is determined for each service data flow of the group of service data flows based on the one or more service requirements for that service data flow; determining one or more group QoS parameters for the group of service data flows in the segment based on the group service requirement; and providing, to the one or more selected user plane entities, the QoS configuration information according to the plurality of QoS parameters for the service data flows of the group of service data flows and according to the group QoS parameter for the group of service data flows.

In an implementation form of the third aspect, the one or more service requirements include an end-to-end service requirement for the service data flow or for each segment of the service data flow linked by one of the application layer computing operations.

In an implementation form of the third aspect, the method further comprises: determining an end-to-end QoS parameter, for example an end-to-end delay, based on an end-to end service requirement received from the application and/or based on the plurality of consecutive segments determined by the control plane entity based on the INC information; and selecting the one or more user plane entities based further on the end-to-end QoS parameter.

In an implementation form of the third aspect, the method further comprises providing, to the one or more selected user plane entities, the QoS configuration information further according to the end-to-end QoS parameter.

In an implementation form of the third aspect, the method further comprises dynamically selecting the one or more user plane entities based on the end-to-end QoS parameter and based on a status of the user plane of the network and/or a load of the user plane entities of the user plane.

In an implementation form of the third aspect, the method further comprises determining the one or more QoS parameters for each segment of the plurality of consecutive segments by mapping said segment to one or more QoS models that exists in the network.

In an implementation form of the third aspect, the method further comprises determining the one or more QoS parameters for each segment of the plurality of consecutive segments based on a QoS granularity, wherein the QoS granularity indicates whether the plurality of QoS parameters relate to a service data flow, or to one or more frames or one or more sub-flows of the service data flow, or to multiple service data flows.

In an implementation form of the third aspect, the QoS configuration information is configured to instruct the one or more selected user plane entities to enforce the plurality of QoS parameters, and/or to enforce the one or more group QoS parameters, and/or to enforce the end-to-end QoS parameter.

In an implementation form of the third aspect, the method further comprises providing, to the one or more selected user plane entities, QoS reporting information which indicates a QoS reporting rule to each of the one or more selected user plane entities for reporting monitoring results related to plurality of QoS parameters to the control plane entity, wherein the monitoring results include at least one of: a monitored packet delay for the packets processed by the application layer at the user plane entities per application; a monitored cross layer latency; a monitored forwarding latency from network layer to application layer; a monitored forwarding latency from application layer to network layer; a monitored forwarding latency between application layer and network layer; a monitored application layer processing delay per application.

The monitoring results may further include at least one of a monitored cross layer packet loss or error rate; a monitored cross layer queue length or congestion level; monitored packet error rate of a segment; a monitored flow bit rate of a segment.

In an implementation form of the third aspect, the method is performed by a PCF and a SMF; wherein the PCF segments the service data flow, and determines the plurality of QoS parameters; and wherein the SMF selects the one or more user plane entities, adjusts the plurality of QoS parameters according to the selected one or more user plane entities, and provides the QoS configuration information to the one or more selected user plane entity.

In an implementation form of the third aspect, the PCF receives the information from the application and provides a QoS policy including at least the plurality of QoS parameters to the SMF.

In an implementation form of the third aspect, the plurality of QoS parameters for the service data flow include one or more of: a packet error rate; a packet delay budget; a guaranteed flow bit rate; a core network packet delay budget; a core network guaranteed flow bit rate; a cross layer latency; a forwarding latency from network layer to application layer; a forwarding latency from application layer to network layer; a forwarding latency between application layer and network layer; an application layer processing delay per application.

The method of the third aspect and its implementation forms achieve the same advantages as the control plane entity of the first aspect and its corresponding implementation forms.

A fourth aspect of this disclosure provides a method for assuring QoS of a service data flow transported through a user plane of a network, the method comprising: receiving a service data flow from another user plane entity, or from a RAN, or from a data network; receiving QoS configuration information from a control plane entity, the QoS configuration information including one or more QoS parameters for the service data flow; and performing an application layer processing operation on the service data flow and enforcing the one or more QoS parameters based on the QoS configuration.

In an implementation form of the fourth aspect, the method further comprises: receiving, from the control plane entity, QoS reporting information which indicates a QoS reporting rule; and providing a report, to the control plane entity after performing the application layer processing on the service data flow, wherein the report indicates whether the one or more QoS parameters could be enforced and/or a value of the one or more enforced QoS parameters and/or of one or more monitored QoS parameters.

In an implementation form of the fourth aspect, the method is performed by a UPF.

The method of the fourth aspect and its implementation forms achieve the same advantages as the user plane entity of the second aspect and its corresponding implementation forms.

A fifth aspect of this disclosure provides a computer program comprising instructions which, when the program is executed by a computer, cause the computer to perform the method according to the third aspect or the fourth aspect or any implementation form thereof.

A sixths aspect of this disclosure provides a non-transitory storage medium storing executable program code which, when executed by a processor, causes the method according to the third aspect or the fourth aspect or any of their implementation forms to be performed.

According to the above aspects and implementation forms, an idea of this disclosure is an enhanced QoS mechanism to support the QoS treatment of service data flows requiring processing by application layer logic in one or more user plane entities during the transport through the (e.g., 3GPP) network.

The enhanced mechanism includes the capability to segment a service data flow and determine the QoS parameters per segmented sector. Further, it may include the capability to manage e2e delay considering dynamically selected network entity for the application layer processing during the transport. Further, it may include the capability to enforce the e2e QoS considering also the latency introduced by the INC.

The enhanced mechanism may be implemented in a 3GPP network, e.g., 5G mobile network, by a set of enhanced control plane and user plane network function (NFs). The control plane NFs may include the PCF to be able to obtain, from the application, an ordered list of identifiers and correspondent service traffic description(s) and service requirements for a service data flow or a group of service flow(s). Further, the PCF may perform QoS segmentation and categorization per sector/segment, and may perform QoS parameter determination per sector/segment. The Control plane NFs may further include the SMF to be able to select the user plane entities and perform multi-segment PDB management. Further, the SMF may configure the user plane entities with enhanced QER or QRR. The user plane NFs may include the cUPFs to be able to apply QoS treatment with the enhanced QER or QRR.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms will be explained in the following description of specific embodiments in relation to the enclosed drawings, in which

FIG. 1 shows a system architecture for service provisioning with control plane NF(s) in a 3GPP network domain.

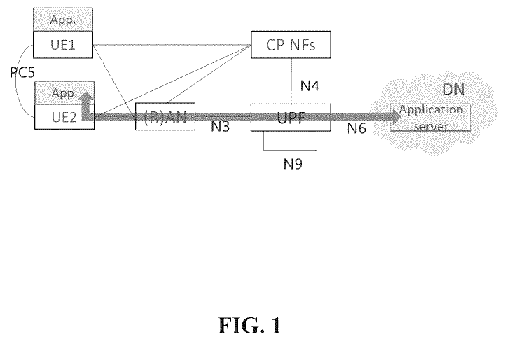

FIG. 2 shows the control of a UPF in a 5G mobile network.

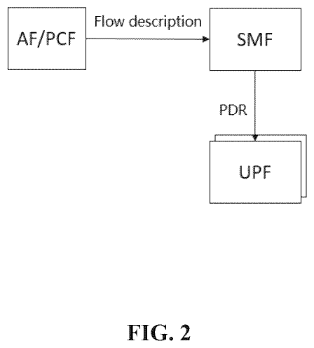

FIG. 3 shows exemplary scenarios for using INC.

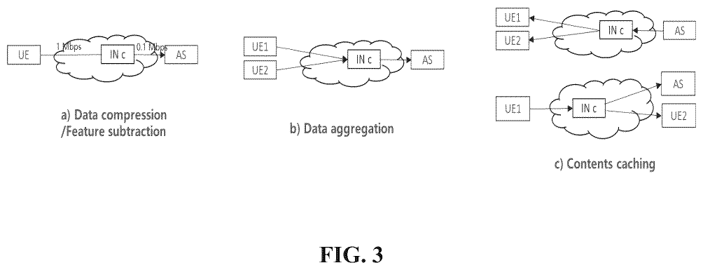

FIG. 4 shows a control plane entity and a user plane entity according to this disclosure.

FIG. 5 shows a high-level architecture (a), and an exemplary QoS control logic (b), for service traffic requiring INC.

FIG. 6 shows an exemplary deployment of user plane entities and of a control plane entity according to this disclosure in a 3GPP network architecture.

FIG. 7 shows exemplary scenarios with multiple user plane entities according to this disclosure, which are deployed in a network for the processing of the same application layer logic.

FIG. 8 shows exemplary scenarios for service data flow segmentation.

FIG. 9 shows an interaction between a control plane entity and a user plane entity according to this disclosure.

FIG. 10 shows an example of an AF providing a flow description and Qos requirements to a control plane entity of a 5GS.

FIG. 11 shows an exemplary PDU session modification procedure triggered by a PCF initiated SM policy association modification.

FIG. 12 shows examples for a N4 procedure for a configuration of a user plane entity according to this disclosure, and a reporting by a user plane entity according to this disclosure.

FIG. 13 shows an exemplary reporting of a user plane entity according to this disclosure to a control plane entity according to this disclosure and a Management Plane (MP), respectively.

FIG. 14 shows a method for a control plane entity, according to this disclosure.

FIG. 15 shows a method for a user plane entity, according to this disclosure.

### DETAILED DESCRIPTION OF EMBODIMENTS

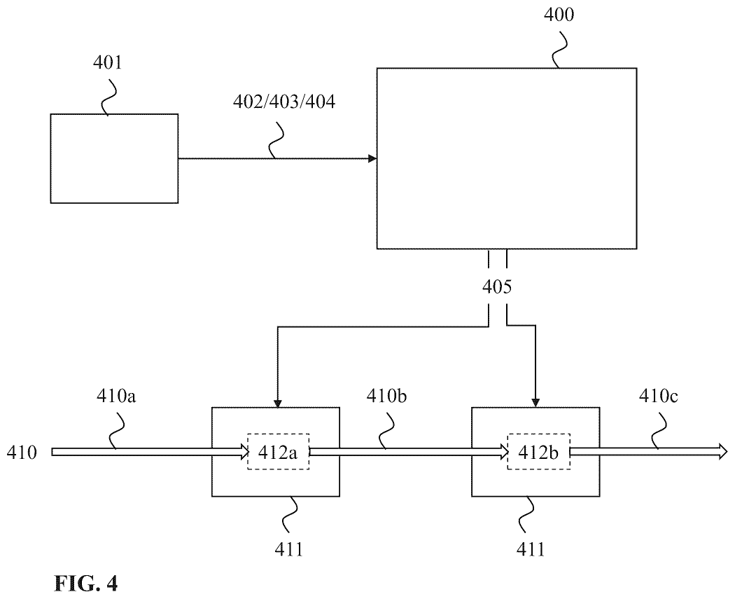

FIG. 4 shows a control plane entity 400, and—just as an example two-user plane entities 411 according to this disclosure. The control plane entity 400 and one or more user plane entities 411 according to this disclosure may be part of a mobile network, for instance, of a 5G mobile network. The control plane entity 400 may comprise a PCF and/or a SMF. Each user plane entity 411 may comprise a UPF. A user plane entity 411 according to this disclosure may be referred to as a cUPF as already mentioned above. The control plane entity 400 and the one or more user plane entities 411 are configured to assure a QoS of a service data flow 410 that is transported through a user plane of the network, as will be described below.

The control plane entity 400 is configured to receive a service description 402 for the service data flow 410, and one or more service requirements 403 for the service data flow 410 from an application. Further, the control plane entity 400 it is configured to receive INC information 404, which includes a list of one or more sets of identifiers. Each identifier in the list is associated with an application layer computing operation 412 (specifically application layer computing operations 412a, 412b are shown in FIG. 4, which may be different operations), which is to be performed on the service data flow 410 in the user plane according to the order in the list. Further, any two or more identifiers in the same set are associated with the same application layer computing operation 412a or 412b, which is to be performed in the user plane.

The control plane entity 400 is further configured to segment the service data flow 410 into a plurality of consecutive segments 410a, 410b, 410c based on the INC information 404. Thereby, each two subsequent segments 410a, 410b, 410c of the segmented service data flow 410 are linked by the application layer computing operations 412a, 412b, which are to be performed on the service data flow 410 in the user plane.

The control plane entity 400 is configured to determine 503 a plurality of QoS parameters for the service data flow 410 based on the one or more service requirements 403. These QoS parameters include one or more QoS parameters for each segment 410a, 410b, 410c of the plurality of consecutive segments of the segmented service data flow 410.

The control plane entity 400 is further configured to select a user plane entity 411 for each set of identifiers in the list based on the INC information 404. Each selected user plane entity 411 is configured to perform the application layer computing operation 412a, 412b that is associated with the identifier. Accordingly, each two subsequent segments 410a, 410b, 410c of the segmented service data flow 410 in the user plane may be linked by a control plane entity 400, which performs an application layer computing operations 412a, 412b on the service data flow 410.

Further, the control plane entity 400 is configured to provide, to the one or more selected user plane entities 411, QoS configuration information 405 according to the plurality of QoS parameters for the service data flow 410.

A user plane entity 411 according to this disclosure is therefore configured to receive the QoS configuration information 405 from the control plane entity 400, and to derive the one or more QoS parameters for the service data flow 410 from the received QoS configuration information 405.

The user plane entity 411 is also configured to receive the service data flow 410. For instance, the user plane entity 411 may receive the service data flow 410 from another user plane entity 411, or from a RAN, or from a DN. The user plane entity 411 is then configured to perform an application layer processing operation 412 (e.g., 412a or 412b) on the service data flow 410. The user plane entity 411 is thereby configured to enforce the one or more QoS parameters according to the QoS configuration information 405.

The control plane entity 400 and/or each user plane entity 411 according to this disclosure may comprise a processor or processing circuitry (not shown) configured to perform, conduct or initiate the various operations of the respective control plane entity 400 and/or user plane entity 411 described herein. The processing circuitry may comprise hardware and/or the processing circuitry may be controlled by software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. The control plane entity 400 and/or each user plane entity 411 may further comprise memory circuitry, which stores one or more instruction(s) that can be executed by the processor or by the processing circuitry, in particular under control of the software. For instance, the memory circuitry may comprise a non-transitory storage medium storing executable software code which, when executed by the processor or the processing circuitry, causes the various operations of the respective control plane entity 400 and/or user plane entity 411 to be performed. In one embodiment, the processing circuitry comprises one or more processors and a non-transitory memory connected to the one or more processors. The non-transitory memory may carry executable program code which, when executed by the one or more processors, causes the respective control plane entity 400 and/or user plane entity 411 to perform, conduct or initiate the operations or methods described herein.

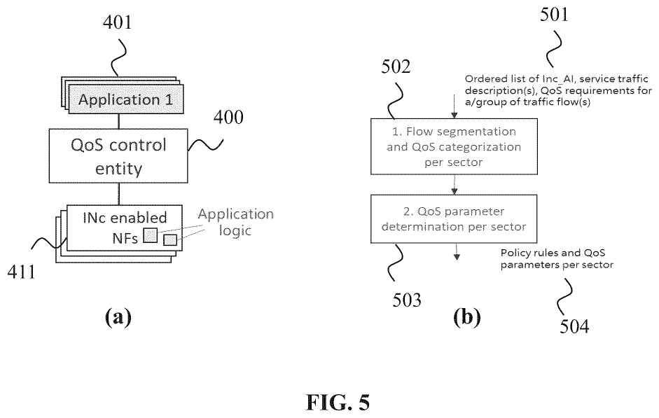

FIG. 5a illustrates a high level view of a control plane entity 400 according to this disclosure-which is exemplarily implemented by a PCF and SMF—wherein the control plane entity 400 interacts with the application 401 to receive 501 the service traffic description 402 and the service requirements 403 for one or more service data flows 410. Further, the control plane entity 400 selects and controls one or more user plane entities 411 (e.g., referred to as INC enabled NFs, e.g. UPFs, with application logic) in the network. FIG. 5b shows an example implementation of the PCF of the control plane entity 400, wherein the PCF is configured to segment the service data flow 410, and to determine the QoS parameters per segment 410a, 410b, 410c.

In step 1, the PCF may segment 502 the service data flow 410 based on the INC information 404, and may map each of the segments 410a, 410b, 410c to one or more QoS models that exist in the mobile network. Thereby, the PCF may consider the traffic pattern resulting from the application layer computing operations 412, and may consider different granularities of QoS treatment (e.g., flow QoS, frame QoS, multicast/broadcast QoS, flow group QoS). That means, for example, the PCF may map the segments 410a, 410b, 410c to the QoS models based on the QoS granularity. The QoS granularity indicates whether QoS models relate to a service data flow 410, or to one or more frames, or one or more sub-flows of the service data flow 410, or to multiple service data flows 410.

In this way, as shown further in step 2, the PCF can determine 503 the one or more QOS parameters for each of the segments 410a, 410b, 410c. In particular, the PCF may determine the related QoS parameters (e.g., 5QI, guaranteed flow bit rate (GFBR)) to be used for each segment 410a, 410b, 410c of the service data flow 410. Then, the PCF may provide 504 these QoS parameters, for instance, as a new combined QoS policy with multiple policy rules and QoS parameters per segment, to the SMF of the control plane entity 400. Each segment may have elastic end points, due to the selection of the user plane entities 411 from multiple candidates deployed in the network. Some QoS parameters, e.g., PDB, may therefore managed by the SMF from an end-to-end perspective, considering also the dynamic selection of the user plane entities 411 based on the selection criteria from the application 401.

The SMF may select the user plane entities 411 and may provide QoS configuration information 405, according to the QoS parameters for the segments 410a, 410b, 410c of the service data flow 410, to the selected user plane entities 411.

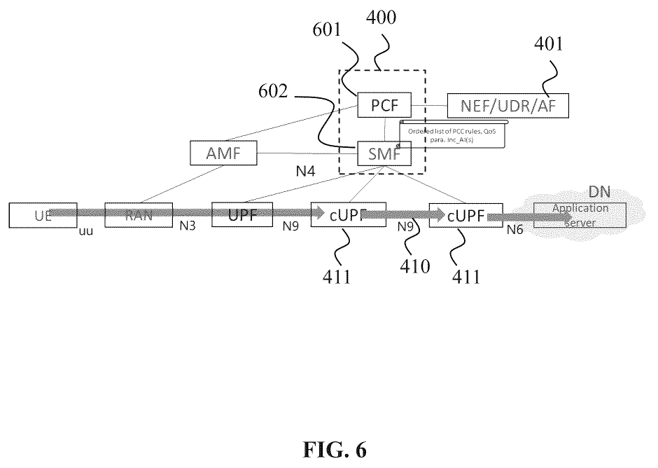

FIG. 6 shows an example 3GPP network architecture with user plane entities 411 according to this disclosure (cUPFs), which are deployed with additional application logic. A UE sends service data to the AS deployed in a DN via the RAN, conventional UPFs, and cUPFs 411. The application 401 provides the PCF 601 of the control plane entity 400 (e.g., via AF, UDR or network exposure function (NEF)) with the service description 402 of the service data flow 410 and the service requirements 403, together with the INC information 404 that comprises the (e.g., ordered) list of identifiers (e.g., referred to as INC access identifiers (INC_AI)). Each INC_AI in the list indicates the access of a cUPF 411 deployed in the 3GPP network. The PCF 601 derives an (e.g., ordered) list of PCC rules and QoS parameters, and provides them to the SMF 602 of the control plane entity 400, together with the list of IN_AI. The SMF 602 selects the cUPFs 411 based on the IN_AIs, and manages the latency of all the segments considering the end-to-end delay requirements. More details of the solutions of this disclosure are described in the following.

This disclosure considers that all the service data flows 410 that require INC are unidirectional, for example, in the UL from the UE to the AS or user plane entity 411 (if terminated there), or in the DL from the AS or user plane entity 411 to the UE. Round trip service data flows, for example, from UE to AS and back to UE, or from a UE1 to a user plane entity 411 and then to a UE2 can be split into an UL service data flow and a DL service data flow, respectively, and can each be treated as a unidirectional service data flow 410 as described above and in the same way.

In a first step, service data flow segmentation and QoS categorization per segment 410a, 410b, 410c is performed at the control plane entity 400 (i.e., service data flow(s) 410→segments 410a, 410b, 410c of the service data flow 410→QoS model for each segment 410a, 410b, 410c). This first step may include breaking the service data flow 410 of the application 401 into multiple connected segments 410a, 410b, 410c per identifier in the INC information 404. Each segment 410a, 410b, 410c may include one flow, or multiple flows with the same destination (e.g., traffic aggregation case) or source (e.g., multicast/broadcast case). This first step may further include mapping each segment 410a, 410b, 410c (with one or more flows) into the existing QoS models (e.g., flow QoS, multi-cast/broadcast service (MBS) QoS, group QoS, frame QoS). Notably, a segment 410a, 410b, 410c can be mapped to multiple QoS models at the same time. For instance, the segment may be mapped to a group QoS on top of flow QoS, mapped to frame QoS on top of flow QoS and/or MBS QoS.

In a second step, one or more QoS parameters may be determined per segment. These QoS parameters per segment may based on the mapped QoS model(s) and the service requirements 403 from the application 401. For example, in case of group QoS on top of flow QoS, the flow QoS parameters (e.g., packet error rate (PER), GFBR) of each flow segment 410a, 410b, 410c may be determined, and the group QoS parameters of all the flow segments of the service data flow 410 may be determined (e.g., allowed arrival time difference among the multiple flows in the group, priority of a flow in the group). The application 401 may either provide the service requirements 403 for end-to-end (e2e) or per segment. In case the service requirements 403 are provided for e2e, a 5GS may derive the service requirements 403 per segment based on the network capability (e.g., using configured/monitored CN-PDB to derive the RAN-PDB, use the e2e requirements directly for the wireless segment in case the CN impact to the QoS parameter is negligible, e.g., PER). A wireless segment may use existing 5G QoS parameters, e.g., 5QI, PER, PDB, GFBR, etc. A wired segment may use core network (CN) specific QoS parameters, e.g., CN-PDB, CN-GFBR.

The CN-PDB may include also the latency at the user plane entity 411 for service data transfer between an application layer and a network layer at the user plane entity 411. This latency corresponds to a first delay (referred to as “Delay_XL” in this disclosure), which can be different in the direction from the network layer to the application layer than in the direction from the application layer to the network layer. The first delay can be a static value determined by the user plane entity's capability or a dynamic value monitored by the user plane entity 411 based on a queue length and a load of the application layer logic at the user plane entity 411, which is used to perform the application layer computing operation 412.

The service data flow segmentation and determination of the QoS parameters per flow segment may be elastic. For instance, the application 401 may deploy the same application logic at multiple user plane entities 411 to serve UEs, e.g., for load balancing, to be on the UE data path to the AS for less latency.

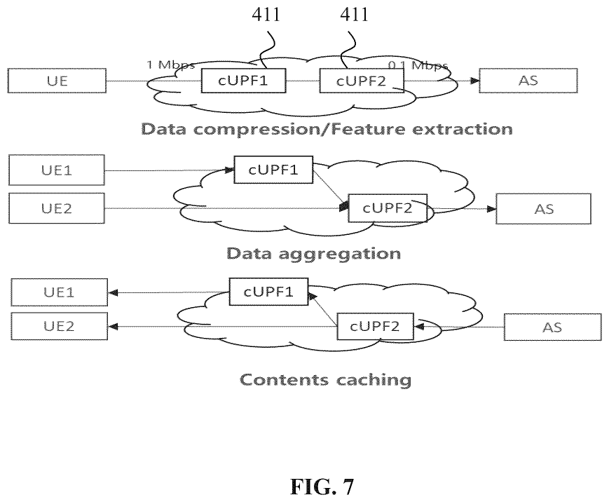

A service data flow 410 from/to a certain UE may be processed by the application layer logic at different user plane entities 411 on the UE data path. As shown in FIG. 7 for the “Data compression/Feature extraction” use case, the service data flow 410 may be processed by the application layer logic at only one of two user plane entities 411 (here cUPF2 instead of cUPF1), since the application 401 or the application layer of cUPF1 is overloaded. In the “Data aggregation” use case, the UE service data may be aggregated either at cUPF1 or at cUPF2 depending on the location of a UE1 and UE2. In the “Contents caching” use case of FIG. 7, the UE may be able to retrieve the requested data on one of the cUPFs on the way, instead of requesting from the AS (if the requested content is available at the cUPF due to the same request of some other UEs). Whether the content is available or not can be either explicitly indicated by the application 401, or can be derived by the mobile network (e.g., similar to the “Data aggregation” use case based on the location of the UEs and correspondent UL traffic of the same application for requesting).

For such cases, multiple identifiers or set of identifiers (e.g., INC_AIs) may be used for each segment 410a, 410b, 410c, of the service data flow 410 (generally service traffic), and each identifier in the set may refer to different candidate user plane entities 411 deployed with the same application layer logic in the network. A high level procedure of the interaction with the application 401 and the identifier selection may be as follows.

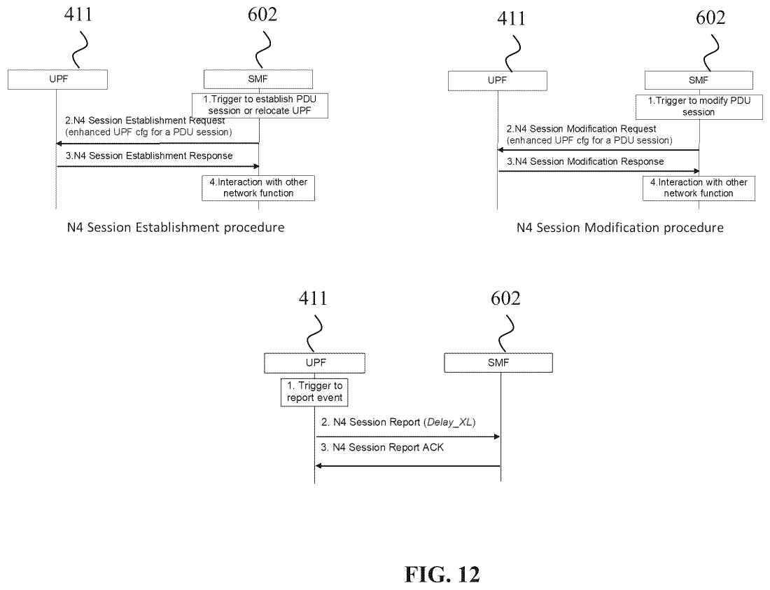

The application 401 (e.g., AF) may provide sets of identifiers for each segment in an ordered list to the control plane entity 400 (e.g., the PCF 601), for instance, using the procedure shown FIG. 12. Each identifier in a set may be associated with selection assistance information to assist the user plane entity 411 selection by the control plane entity 400. The selection assistance information may include the following: selection probability; On/off status; serving area (e.g., list of cell IDs or tracking area(s) where to be served UEs are allocated) of the user plane entity 411 indicated by that identifier. Each set of identifers may be associated with selection criteria. The selection criteria may include the following: communication latency between the UE(s) when using the user plane entity 411 indicated by that identifier is low than a certain threshold; the application layer processing load situation of the correspondent user plane entity 411 indicated by that identifier is lower than a certain threshold (e.g., if the first delay (Delay_XL) is smaller than a threshold).

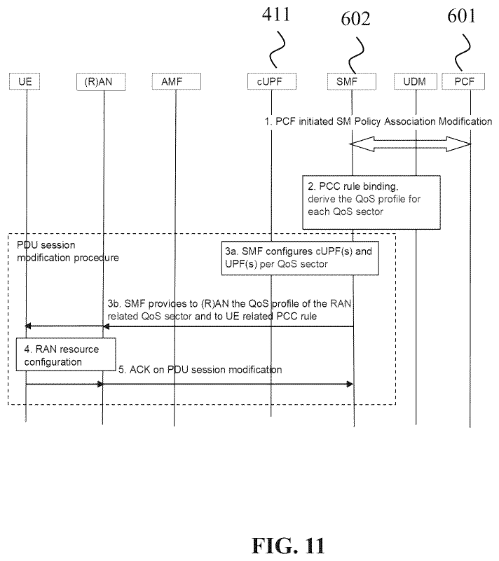

The PCF 601 of the control plane entity 400 may identify the responsible SMF 602 of the control plane entity 400, and may provide the list of identifiers and the selection assistance information or selection criteria to the responsible SMF 602, for instance, as in step 1 of the procedure shown FIG. 11. The SMF 602 may derive the identifiers from the received ordered list of sets of identifiers based on a monitored status of a user plane entity 411, UE locations and the selection assistance information or selection criteria, for instance, as in step 2 of the procedure shown FIG. 11.

For QoS parameter determination, the PCF 601 may obtain the service requirements 403 of the service data flow 410 regarding e2e flow instead of per flow segment from the AF or unified data repository (UDR). The PCF 601 or the SMF 602 may derive the QoS parameters for each flow segment 410a, 410b, 410c based on the list of identifiers in the INC information 404 and a list of service flow description(s) 402 with the following principle.

The PCF 601 derives the PDB from e2e flow requirements and provides it together with a second delay (referred to as “Delay_Comp”) per identifier (provided by AF) to SMF 602. The SMF 602 splits PDB further into AN_PDB and CN_PDB(s) considering a second delay per identifier and second delay per identifier reported from the user plane entity 411.

The PCF 601 derives other QoS parameters from the e2e flow requirements and use that for the wireless QoS segments.

Three examples are given as below to show how the above procedure works for flow segmentation and QoS parameter determination. An access identifier of the DN (DNAI), wherein the AS is deployed.

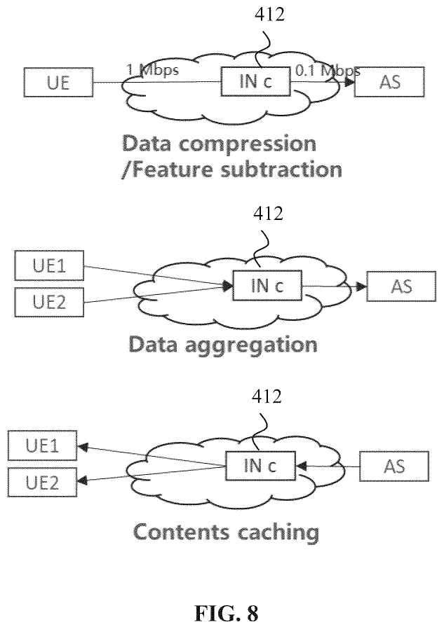

A first example relates to the scenario 1 of FIG. 8.

In the first example, the service description 402 and the service requirements 403 from the application 401 are:
FL1: [UE IP→INC_AI→DNAI, app 1], FL group 1, PDB=6 ms,
FL2: [UE IP→INC_AI→DNAI, app 1], FL group 1, PDB=6 ms,

### Synchronized Delivery

In the first example, the determined QoS parameters in the 5GS are:

Flow segment 1: (group QoS)
FL1: [UE IP→INC_AI, app 1], FL group 1, 5QI=87
FL2: [UE IP→INC_AI, app 1], FL group 1, 5QI=87

### Synchronized Delivery

Flow segment 2:
[INC_AI→DNAI, app 1], CN-PDB=1 ms

A second example relates to the scenario 2 of FIG. 8.

In the second example, the service description 402 and the service requirements 403 from the application 401 are:
[UE IP→INC_AI→DNAI, app 1], PDB=6 ms, GFBR=1 Mbps

In the second example, the determined QoS parameters in the 5GS are:

### Flow Segment 1:

[UE IP→INC_AI, app 1], 5QI=87, GFBR=1 Mbps

### Flow Segment 2:

[INC_AI→DNAI, app 1], CN-PDB=1 ms, CN-FBR=0.1 Mbps

A third example relates to scenario 3 of FIG. 8.

In the third example, the service description 402 and the service requirements 403 from the application 401 are:
[DNAI→INC_AI→multicast address, app 1], PDB=6 ms

In the third example, the determined QoS parameters in the 5GS are:

### Flow Segment 1:

[DNAI→INC_AI, app 1], CN-PDB=1 ms

### Flow Segment 2: (MBS QoS)

[INC_I→UE1/2 multicast address, app 1], 5QI=87

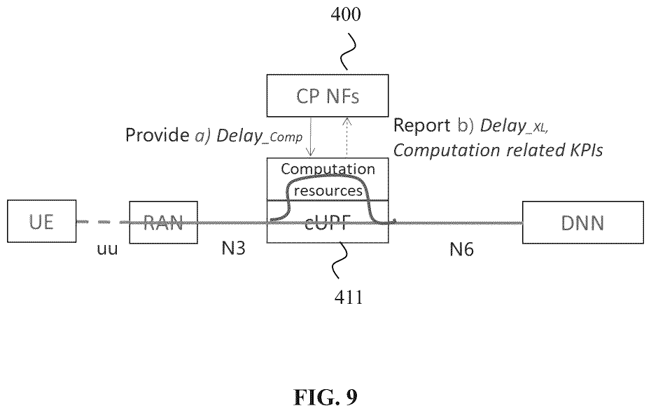

In the following, QoS treatment considering local application layer processing at the user plane entity 411 is described with reference to FIG. 9. The current user plane entity 411 may perform packet dropping in case PDB is exceeded and report to SMF 602 on the measurement of data plane latency. When the user plane entity 411 is used, the data plane latency includes not only the processing latency at the network layer, but also (a) the processing latency at the application layer at the user plane entity 411 (first delay; Delay_Comp) and (b) communication latency (second delay; Delay_XL) between the application layer and network layer at the user plane entity 411.

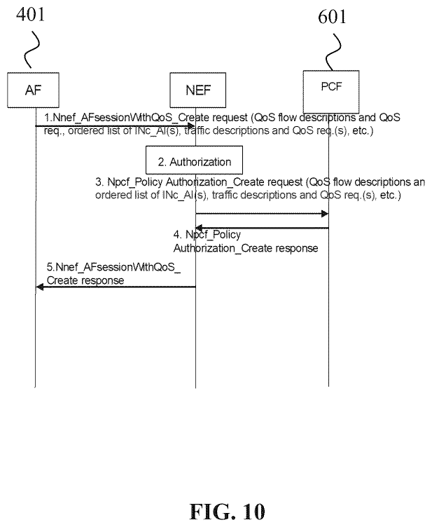

The first delay is provided by the AF to the SMF 602 using, for instance, the procedure in FIG. 10, and step 1 in FIG. 11. The SMF 602 provides it further to the user plane entity 411 using the N4 configuration procedure (FIG. 12). The second delay is measured by a user plane entity 411, and can be reported to the SMF/PCF/AF as the computation related KPIs using the existing N4 reporting procedure to the SMF 602 (FIG. 12) and notification procedure (to the PCF/AF; FIG. 12). Other computation related KPIs include: XL_packet loss rate, XL_queue length/congestion level, etc.

For QoS monitoring, the monitored latency at a user plane entity 411 according to this disclosure (cUPF) may be equal to the monitored latency at a user plane entity not used for application layer processing (UPF) plus the second delay (Delay_Comp) plus two times the first delay (2× Delay_XL).

For packet scheduling and queue management, a latency threshold for a packet drop (Pkt_drop_latency_threshold) at the user plane entity 411 according to this disclosure may be equal to the monitored latency at a user plane entity not used for application layer processing (UPF) plus the first delay (Delay_XL).

An example procedure is shown in FIG. 10 and FIG. 11 and includes:
1. The AF provides an (ordered) list of flow descriptions (service descriptions 402) and QoS requirements 403 to the PCF 601 together with the ordered list of identifiers (INC_AI(s)) in the INC information, using the procedure in FIG. 10. Each set of flow descriptions 402 and QoS requirements 403 applies to one flow segment on the service data path in the network. The AF may provide also the second delay (Delay_Comp) in this step per the identifiers. The AF may also provide the QoS requirements 403 for e2e instead of per segment. In the case that a set of identifiers are provided for each segment, the AF provides additional the selection assistance information or selection criteria as described above with respect to the clastic QoS flow segmentation, wherein a resegmentation of the service data flow may be done. Notably, each segment of flow description could also be a set of flow description(s), where the set of flows require the same treatment in the network.
2. The PCF 601 provides derived PCC rules (including a list of sets of flow description(s) and QoS parameters) and a list of identifiers to the SMF 602 using policy association procedure (e.g. as in FIG. 11, step 1).
3. The SMF 602 selects the user plane entities 411 based on the list of identifiers and the selection criteria, and derives the QoS profile for each QoS sector/segment based on the PCC rule from PCF (FIG. 11, step 2).
4. The SMF 602 configures the user plane entities 411 with enhanced rules (including, e.g., enhanced QER, QRR) in FIG. 11, step 3a, and provides the QoS profile of the RAN related segment to the RAN during the PDU session modification procedure as shown in FIG. 11, step 3b.

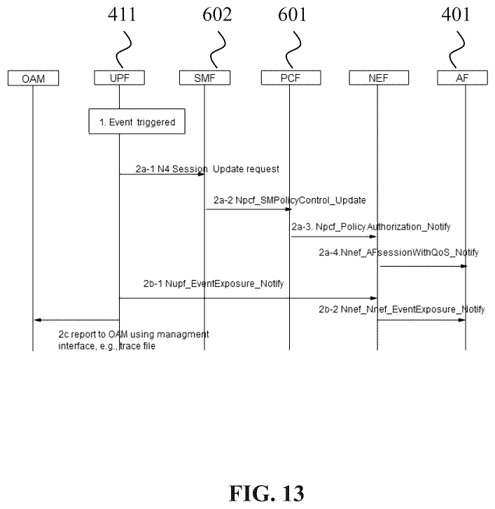

FIGS. 12 and 13 shows a configuration and reporting procedure of a user plane entity 411 of this disclosure. In particular, FIG. 12 shows a N4 session establishment procedure, a N4 session modification procedure, and a N4 procedure for user plane entity 411 reporting.

The control plane entity 400 may be configured to provide, to each selected user plane entities 411 of this disclosure, QoS reporting information which indicates a QoS reporting rule. The reporting rule is for reporting monitoring results related to plurality of QoS parameters to the control plane entity 400. The monitoring results may include at least one of: a monitored packet delay for the packets processed by the application layer at the user plane entities 411 per application 401; a monitored cross layer latency; a monitored forwarding latency from network layer to application layer; a monitored forwarding latency from application layer to network layer; a monitored forwarding latency between application layer and network layer; and a monitored application layer processing delay per application.

The monitoring results may further include at least one of a monitored cross layer packet loss or error rate; a monitored cross layer queue length or congestion level; monitored packet error rate of a segment; a monitored flow bit rate of a segment.

The user plane entity 411 may also report computation-related KPIs (including Delay_XL) to the PCF and/or AF via CP (SMF/PCF/NEF) as shown in FIG. 13, step 2a, or report the computation related KPIs (including Delay_XL) to AF via UP as shown in FIG. 13, step 2b, or report the computation related KPIs (including Delay_XL) to OAM via management interface as shown in FIG. 13, step 2c.

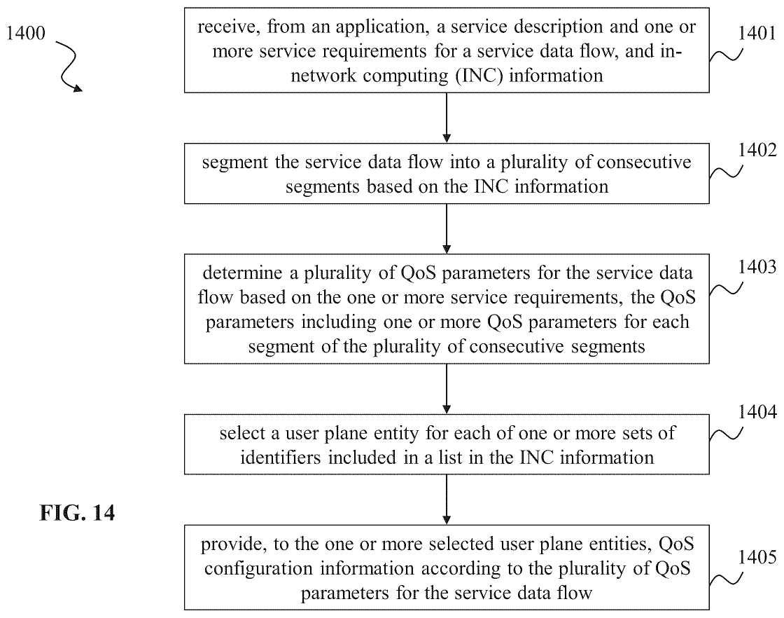

FIG. 14 shows a method 1400 for assuring QoS of a service data flow 410 transported through a user plane of a network. The method 1400 of this disclosure may be carried out by the control plane entity 400.

Accordingly, the method 1400 comprises a step 1401 of receiving, from an application 401, a service description 402 for the service data flow 410, one or more service requirements 403 for the service data flow 410, and INC information 404. The INC information 404 includes a list of one or more sets of identifiers, wherein each identifier is associated with an application layer computing operation 412 to be performed on the service data flow 410 in the user plane. The identifiers in the same set are associated with the same application layer computing operation 412.

The method 1400 further comprises a step 1402 of segmenting the service data flow 410 into a plurality of consecutive segments 410a, 410b, 410c based on the INC information 404. Each two subsequent segments 410a, 410b, 410c are linked by one of the application layer computing operations 412 (e.g., 412a, 412b) to be performed on the service data flow 410 in the user plane.

The method 1400 further comprises a step 1403 of determining a plurality of QoS parameters for the service data flow 410 based on the one or more service requirements 403. The plurality of QoS parameters include one or more QoS parameters for each segment 410a, 410b, 410c of the plurality of consecutive segments.

The method 1400 further comprises a step 1404 of selecting a user plane entity 411 for each set of identifiers in the list based on the INC information 404. Each selected user plane entity 411 is configured to perform the application layer computing operation 412 that is associated with the identifier.

Step 1404 may determine further QoS parameters (e.g., PDB) for each segment based on the selected user plane entities. Notably, the steps 1403 and 1404 may be performed together.

The method 1400 further comprises a step 1405 of providing, to the one or more selected user plane entities 411, QoS configuration information 405 according to the plurality of QoS parameters for the service data flow 410.

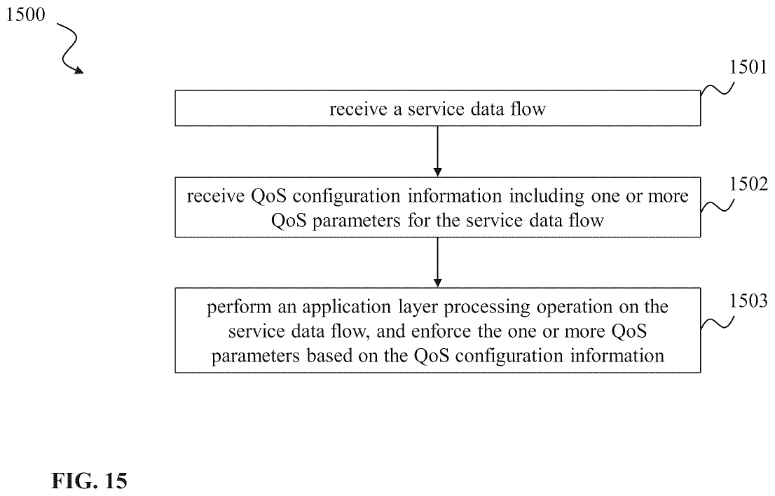

FIG. 15 shows a method 1500 for assuring QoS of a service data flow 410 transported through a user plane of a network. The method 1500 of this disclosure may be performed by a user plane entity 411 of this disclosure.

The method 1500 comprises a step 1501 of receiving a service data flow 410 from another user plane entity, or from a RAN, or from a data network, and a step 1502 of receiving QoS configuration information 405. The QoS information includes one or more QoS parameters for the service data flow 410.

The method 1500 also comprises a step 1503 of performing an application layer processing operation 412 on the service data flow 410, and of enforcing the one or more QoS parameters based on the QoS configuration information 405.

In summary, this disclosure provides flow segmentation and QoS parameter determination per flow segment (at a control plane entity 400, which may comprise PCF 601 and/or SMF 602). Thus, the disclosure enable e2e QoS assurance in a mobile network, even considering complex traffic patterns caused by intermediate application layer processing during the traffic transport through the user plane of the network. The disclosure further provides the possibility for a dynamic user plane entity 411 selection based on one or more selection criteria from the application 401, and/or based on a dynamic network status. Thus, the solution of this disclosure is scalable and distributed INC logic deployment in mobile network. Further, this disclosure provides enhanced QoS enforcement and reporting for INC (at the user plane entity 411). Thus, it enables e2e QoS assurance with INC deployed at the user plane in the network.

The present disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. A method (1400) for assuring quality of service (QOS) of a service data flow (410) transported through a user plane of a network, the method (1400) comprising:
receive (501), from an application (401), a service description (402) for a service data flow (410) and one or more service requirements (403) for the service data flow (410), and in-network computing (INC) information (404) including a list of one or more sets of identifiers, wherein each identifier is associated with an application layer computing operation (412, 412a, 412b) to be performed on the service data flow (410) in the user plane, and wherein the identifiers in the same set are associated with the same application layer computing operation (412, 412a, 412b);
segment (502) the service data flow (410) into a plurality of consecutive segments (410a, 410b, 410c) based on the INC information (404), wherein each two subsequent segments (410a, 410b, 410c) are linked by one of the application layer computing operations (412, 412a, 412b) to be performed on the service data flow (410) in the user plane;
determine (503) a plurality of QoS parameters for the service data flow (410) based on the one or more service requirements (403), wherein the plurality of QoS parameters include one or more QoS parameters for each segment (410a, 410b, 410c) of the plurality of consecutive segments;
select a user plane entity (411) for each set of identifiers in the list based on the INC information (404), wherein each selected user plane entity (411) is configured to perform the application layer computing operation (412, 412a, 412b) that is associated with the identifier; and
provide (504), to the one or more selected user plane entities (411), QoS configuration information (405) according to the plurality of QoS parameters for the service data flow (410).

2. The method according to claim 1, further comprises:
receive, from the application (401), a service description (402) indicating a group of service data flows (410) that are associated with each other, a group service requirement for the group of service data flows (410), and one or more service requirements (403) for each service data flow (410) of the group of service data flows (410);
identify the segments (410a, 410b, 410c) with a group of service data flows (410);
determine the plurality of QoS parameters for the group of service data flows (410) in the segment (410a, 410b, 410c), wherein a set of QoS parameters is determined for each service data flow (410) of the group of service data flows based on the one or more service requirements (403) for that service data flow (410);
determine one or more group QoS parameters for the group of service data flows (410) in the segment (410a, 410b, 410c) based on the group service requirement; and
provide, to the one or more selected user plane entities (411), the QoS configuration information (405) according to the plurality of QoS parameters for the service data flows (410) of the group of service data flows and according to the group QoS parameter for the group of service data flows (410).

3. The method according to claim 1, wherein the one or more service requirements (403) include an end-to-end service requirement for the service data flow (410) or for each segment (410a, 410b, 410c) of the service data flow (410) linked by one of the application layer computing operations (412, 412a, 412b).

4. The method according to claim 1, further comprises:
determine an end-to-end QoS parameter, based on one or more of an end-to end service requirement received from the application (401), or based on the plurality of consecutive segments (410a, 410b, 410c) determined by the control plane entity (400) based on the INC information (404); and
select the one or more user plane entities (411) based further on the end-to-end QoS parameter.

5. The method according to claim 4, further comprises:
provide, to the one or more selected user plane entities (411), the QoS configuration information (405) further according to the end-to-end QoS parameter.

6. The method according to claim 4, further comprises:
dynamically select the one or more user plane entities (411) based on the end-to-end QoS parameter and based on one or more of a status of the user plane of the network or a load of the user plane entities (411) of the user plane.

7. The method according to claim 1, further comprises:
determine the one or more QoS parameters for each segment (410a, 410b, 410c) of the plurality of consecutive segments by mapping said segment (410a, 410b, 410c) to one or more QoS models that exists in the network.

8. The method according to claim 1, further comprises:
determine the one or more QoS parameters for each segment (410a, 410b, 410c) of the plurality of consecutive segments based on a QoS granularity, wherein the QoS granularity indicates whether the plurality of QoS parameters relate to a service data flow (410), or to one or more frames or one or more sub-flows of the service data flow (410), or to multiple service data flows (410).

9. The method according to claim 1, wherein the QoS configuration information (405) is configured to instruct the one or more selected user plane entities (411) to enforce the one or more of plurality of QoS parameters, the one or more group QoS parameters, or the end-to-end QoS parameter.

10. The method according to claim 1, further comprises:
provide, to the one or more selected user plane entities (411), QoS reporting information which indicates a QoS reporting rule to each of the one or more selected user plane entities (411) for reporting monitoring results related to plurality of QoS parameters to the control plane entity (400), wherein the monitoring results include at least one of:
a monitored packet delay for the packets processed by a application layer at the user plane entities (411) per application (401);
a monitored cross layer latency;
a monitored forwarding latency from network layer to application layer;
a monitored forwarding latency from application layer to network layer;
a monitored forwarding latency between application layer and network layer;
a monitored application layer processing delay per application.

11. The method according to claim 1, wherein the control plane entity (400) comprises a policy control function (PCF), (601) and a session management function (SMF) (602);
wherein the PCF (601) is configured to segment the service data flow (410), and to determine the plurality of QoS parameters; and
wherein the SMF (602) is configured to select the one or more user plane entities (411), adjust the plurality of QoS parameters according to the selected one or more user plane entities (411), and to provide the QoS configuration information (405) to the one or more selected user plane entities (401).

12. The method according to claim 11, wherein the PCF (601) is configured to receive the information from the application (401) and provide a QoS policy including at least the plurality of QoS parameters to the SMF (602).

13. The method according to claim 1, wherein the plurality of QoS parameters for the service data flow (410) include one or more of:
a packet error rate;
a packet delay budget;
a guaranteed flow bit rate;
a core network packet delay budget;
a core network guaranteed flow bit rate;
a cross layer latency;
a forwarding latency from network layer to application layer;
a forwarding latency from application layer to network layer;
a forwarding latency between application layer and network layer;
an application layer processing delay per application (401).

14. A method (1500) for assuring quality of service (QOS) of a service data flow (410) transported through a user plane of a network, the method (1500) comprising:
receive a service data flow (410) from another user plane entity, or from a RAN, or from a data network;
receive QoS configuration information (405) from a control plane entity (400), the QoS configuration information (405) including one or more QoS parameters for the service data flow (410); and
perform an application layer processing operation (412, 412a, 412b) on the service data flow (410); and
enforce the one or more QoS parameters based on the QoS configuration information (405).

15. The method according to claim 14, further comprises:
receive, from the control plane entity (400), QOS reporting information which indicates a QoS reporting rule; and
provide a report, to the control plane entity (400) after performing the application layer processing operation (412, 412a, 412b) on the service data flow (410), wherein the report indicates whether enforced at least one of the one or more QoS parameters, a value of the one or more enforced QoS parameters, or a value of one or more monitored QoS parameters.

16. The method according to claim 14, wherein the user plane entity (411) is a user plane function.

17. A computer program comprising instructions which, when the program is executed by a computer, cause the computer to perform:
receiving (1401), from an application (401), a service description (402) for the service data flow (410) and one or more service requirements (403) for the service data flow (410), and in-network computing (INC) information (404) including a list of one or more sets of identifiers, wherein each identifier is associated with an application layer computing operation (412, 412a, 412b) to be performed on the service data flow (410) in the user plane, and wherein the identifiers in the same set are associated with the same application layer computing operation (412, 412a, 412b);
segmenting (1402) the service data flow (410) into a plurality of consecutive segments (410a, 410b, 410c) based on the INC information (404), wherein each two subsequent segments (410a, 410b, 410c) are linked by one of the application layer computing operations (412, 412a, 412b) to be performed on the service data flow (410) in the user plane;
determining (1403) a plurality of QoS parameters for the service data flow (410) based on the one or more service requirements (403), wherein the plurality of QoS parameters include one or more QoS parameters for each segment (410a, 410b, 410c) of the plurality of consecutive segments;
selecting (1404) a user plane entity (411) for each set of identifiers in the list based on the INC information (404), wherein each selected user plane entity (411) is configured to perform the application layer computing operation (412, 412a, 412b) that is associated with the identifier; and
providing (1405), to the one or more selected user plane entities (411), QoS configuration information (405) according to the plurality of QOS parameters for the service data flow (410).

18. A computer program comprising instructions which, when the program is executed by a computer, cause the computer to perform:
receiving (1501) a service data flow (410) from another user plane entity, or from a RAN, or from a data network;
receiving (1502) QOS configuration information (405), the QoS configuration information including one or more QoS parameters for the service data flow; and
performing (1503) an application layer processing operation (412, 412a, 412b) on the service data flow (410) and enforcing the one or more QoS parameters based on the QoS configuration information (405).
